(19) United States
(12) Patent Application Publication
(10) Pub. No.: US 2023/0055278 A1
(43) Pub. Date: Feb. 23, 2023

(54) POWER CONTROLS OF COMPUTING DEVICES

(71) Applicant: Hewlett-Packard Development Company, L.P., Spring, TX (US)

(72) Inventors: Hou-Chu Su, Taipei City (TW); Wei-Ming Tseng, Taipei City (TW); Lien-Chia Chiu, Taipei City (TW); Chien-Feng Chu, Taipei City (TW)

(73) Assignee: Hewlett-Packard Development Company, L.P., Spring, TX (US)

(21) Appl. No.: 17/799,943

(22) PCT Filed: Mar. 9, 2020
(86) PCT No.: PCT/US2020/021639

§ 371 Date: Aug. 16, 2022

(51) Int. Cl. G06F 1/32; H02J 1/08

(52) U.S. Cl. CPC G06F 1/32; H02J 1/084

(57) ABSTRACT

An example computing device includes a power switch, a power management device to control a power state change of the computing device based on a command from a power control device, and a controller. The controller is to, in response to receiving a power control request message from an external device, change the power control device from the power switch to the external device.

### BACKGROUND

A computing device, such as a laptop computer, may include a power switch to turn on or off the computing device. The power switch may be implemented as a power button disposed in the housing of the computing device.

### BRIEF DESCRIPTION OF THE DRAWINGS

Some examples of the present application are described with respect to the following figures:

FIG. *I illustrates a system where an external device is to control a power state change of a computing device, according to an example;

FIGS. 2A-2B illustrate a computing device to control a connection between a power switch and a power management device, according to an example;

FIG. 3 illustrates an operation flow at a computing device and an external device to enable the external device to control a power state change of the computing device, according to an example;

FIG. 4 illustrates a system where an input device is to control a power state change of a laptop computer, according to an example;

FIG. 5 illustrates a computing device to receive a command from an external device to control a power state change, according to an example;

FIG. 6 illustrates an electronic device to control a power state change of a computing device, according to an example;

FIG. 7 illustrates a computing device to receive a command from an external device to control a power state change, according to another example; and

FIG. 8 illustrates an electronic device to control a power state change of a computing device, according to another example.

### DETAILED DESCRIPTION

The power button may be used to turn on or off a computing device as long as the power button is pressed regardless of the identity of the person performing the action. Thus, the power button may present a security risk as an unauthorized person may turn on a computing device by pressing the power button and gain access to the data in the computing device. An unauthorized person may also turn off a computing device to interrupt operations executing on the computing device by pressing the power button.

Examples described herein provide an approach to protect a power button of a computing device against unauthorized use. In an example, a computing device may include a power switch, a power management device to control a power state change of the computing device based on a command from a power control device, and a controller. The controller may, in response to receiving a power control request message from an external device, change the power control device from the power switch to the external device.

In another example, a computing device may include a power switch, a power management device, and a controller. The controller may, in response to receiving a power control request message from an external device, disable the power switch. The controller may also, in response to receiving a command from the external device, assert the command to the power management device to change a power state of the computing device.

In another example, a system may include a computing device having a power switch, where the power switch may control a power state change of the computing device. The system may also include an input device. The input device may transmit a power control request message to the computing device wirelessly to disable the power switch. The input device may also transmit a command to the computing device to control the power state. Thus, examples described herein may enable a computing device to disable a power button of the computing device and receive a command from an external device to control a power state change of the computing device.

FIG. 1 illustrates a system 100 where an external device is to control a power state change of a computing device, according to an example. System 100 may include a computing device 102 and an external device 104. Computing device 102 may be, a laptop computer, a desktop computer, an all-in-one system, a tablet computing device, a mobile phone, an electronic book reader, or any computing device with an integrated power switch.

Computing device 102 may include a controller 106, a power switch 108, and a power management device 110. Controller 106 may provide a command or signal to power management device 110 to change a power state of computing device 102, such as turning off computing device 102 or turning on computing device 102. Controller 106 may be implemented as an Application-Specific Integrated Circuit (ASIC). In some examples, controller 106 may be implemented using a Field Programmable Gate Array (FPGA).

Power switch 108 may be a hardware device or circuit that makes or breaks a connection between a power source and components of computing device 102. Power switch 108 may be implemented using a tactile switch, Other mechanical switch, electro-mechanical, contactless switch (e.g,, proximity switch), may also implement power switch 108. In some examples, power switch 108 may be disposed in a button housing to form a power button.

Power management device 110 may be implemented using hardware, instructions, or a combination thereof to perform management in computing device 102, including controlling a power state change of computing device 102. In some examples, computing device 102 may implement the Advanced Configuration Power Interface (ACPI) specification. Thus, computing device 102 may have different power states as defined by ACPI: S0, S1, S2, 53, S4, and S5. As an example, S0 may be a power state where computing device 102 is running and a processor of computing device 102 is executing instructions. In some examples, power management device 110 may be implemented using a semiconductor-based controller, registers, and instructions executable by the controller.

External device 104 may be, a laptop computer, a desktop computer, an all-in-one system, a tablet computing device, a mobile phone, an electronic book reader, an electronic input device (e.g., a stylus, an active pen), or any electronic device suitable to transmit a command or signal wirelessly (e.g., via radio waves).

During operation, power management device 110 may be connected to power switch 108. When power switch 108 is engaged (e.g., pressed), power switch 108 may assert a command or signal to power management device 110 to indicate a power state change is requested. Power management device 110 may change a power state of computing device 102 accordingly. For example, when computing device 102 is in the S0 state (i.e., working state or on state), in response to the command from power switch 108, power management device 110 may cause computing device 102 to change from the S0 state to the S5 state (Le., soft off state).

External device 104 may transmit a power control request message 112 to computing device 102 wirelessly. In response to receiving power control request message 112 at computing device 102, controller 106 may disable power switch 108 so that an engagement of power switch 108 is not able to assert a command to power management device 110 to cause a power state change. In some examples, power control request message 112 may include a device identifier of external device 104 so computing device 102 is able to determine external device 104 is an authorized device to issue power control request message 12.

In some examples, in response to receiving power control request message 112, controller 106 may also establish a wireless connection with external device 104. In some examples, external device 104 and controller 106 may be tuned to communicate at a particular frequency to avoid connection setup.

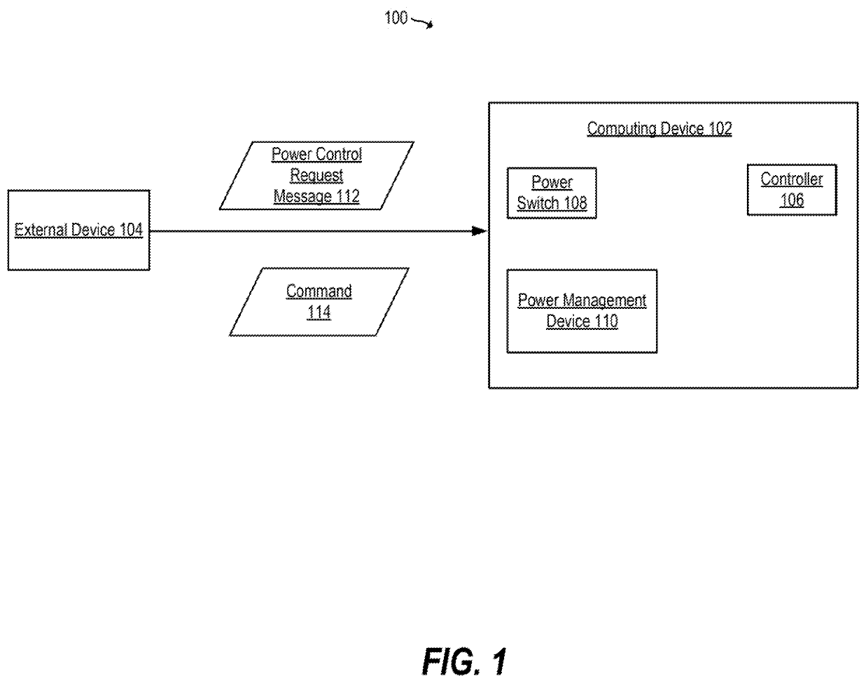

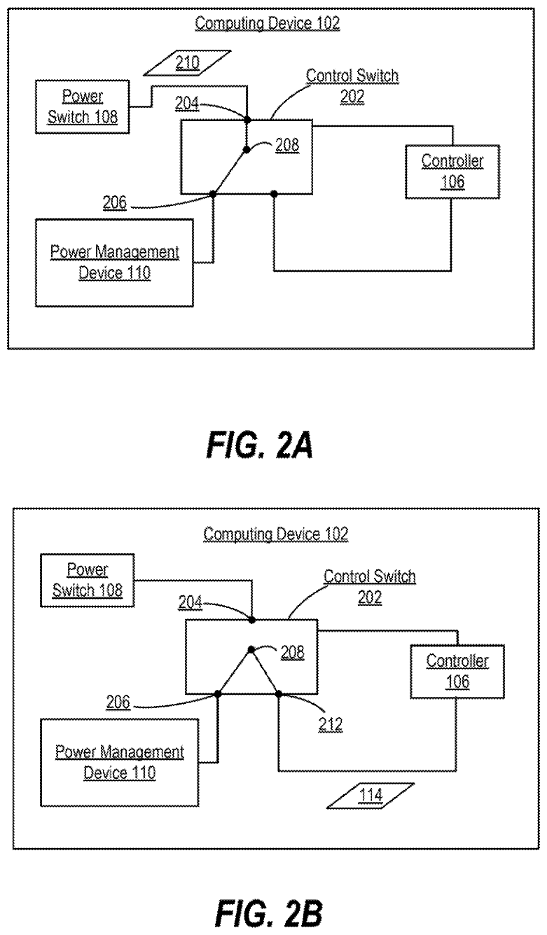

External device 104 may transmit a command 114 to computing device 102 to change a power state of computing device 102. In response to receiving command 114, controller 106 may assert command 114 to power management device 110 to cause a power state change of computing device 102. At any time, only one of power switch 108 and external device 104 is able to assert a command to cause a power state change of computing device 102. Thus, by disabling power switch 108 via controller 106, an authorized user may use external device 104 as the single power control device to control a power state change of computing device 102 while protecting power switch 108 against unauthorized use. An example of disabling power switch 108 is described in more detail in FIGS. 2A-2B.

FIGS. 2A-2B illustrate computing device 102 to control a connection between a power switch and a power management device, according to an example. Turning to FIG. 2A, computing device 102 may include a control switch 202 to control connections among controller 106, power switch 108, and power management device 110. Control switch 202 may be implemented using a mechanical switch, an electro-mechanical switch, an electronic device (e.g., a multiplexor), or any other type of switch suitable to change connections among multiple circuits/devices.

As illustrated in FIG. 2A, power switch 108 may be enabled. When enabled, power switch 108 may be connected to power management device 110 via control switch 202. Power switch 108 may be connected to a node 204 of control switch (e.g., via wire trace or cable). Power management device 110 may be connected to a node 206 of control switch 202. Both nodes 204 and 206 may be connected to a node 208 of control switch 202. Thus, when power switch 108 is engaged, power switch 108 may assert a command 210 to power management device 110 via nodes 204, 208, and 206 of control switch 202 to cause a power state change of computing device 102.

Turning to FIG. 2B, computing device 102 may disable power switch 108 via control switch 202 in response to receiving power control request message 112. Controller 106 may configure or set control switch 202 to disconnect node 204 from node 208. By disconnecting node 204 from node 208, power switch 108 is not able to assert any command to power management device 110 as there is no electrical connection or communication path between power switch 108 and power management device 110 Thus, power switch 108 is disabled.

Controller 106 may configure control switch 202 to connect node 206 to a node 212 of control switch 202 via node 208. Thus, controller 106 may be connected to power management device 110. Controller 106 may assert a command, such as command 114, to power management device 110 via nodes 210, 208, and 206 to cause a power state change of computing device 102. To re-enable power switch 108, controller 106 may configure control switch 202 to connect node 206 to node 204 again via node 208.

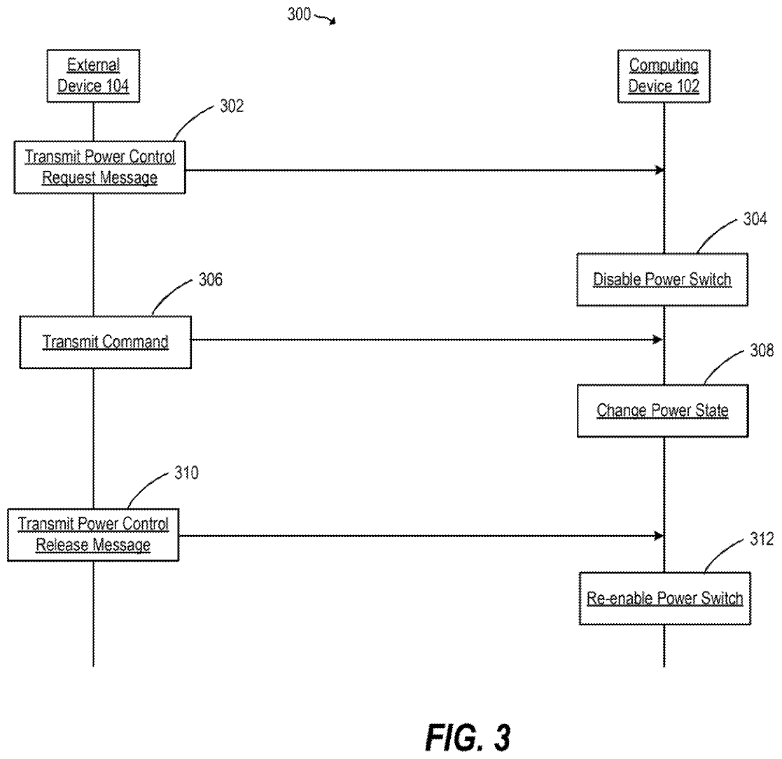

FIG. 3 illustrates an operation flow 300 at a computing device and an external device to enable the external device to control a power state change of the computing device, according to an example. At 302, external device 104 may transmit power control request message 112 to computing device 102. Power control request message 112 may be used to establish a wireless connection between external device 104 and computing device 102. At 304, in response to receiving power control request message 112, computing device 102 may disable power switch 108. At 306, external device 104 may transmit command 114 to computing device 102. At 308, in response to receiving command 114, computing device 102 may change power state. For example, computing device 102 may transition from a working state to an off state in response to receiving command 114.

At 310, external device 104 may transmit a power control release message to computing device 102,. At 312, in response to receiving power control release message, computing device 102 may re-enable power switch 108 to control a power state change of computing device 102.

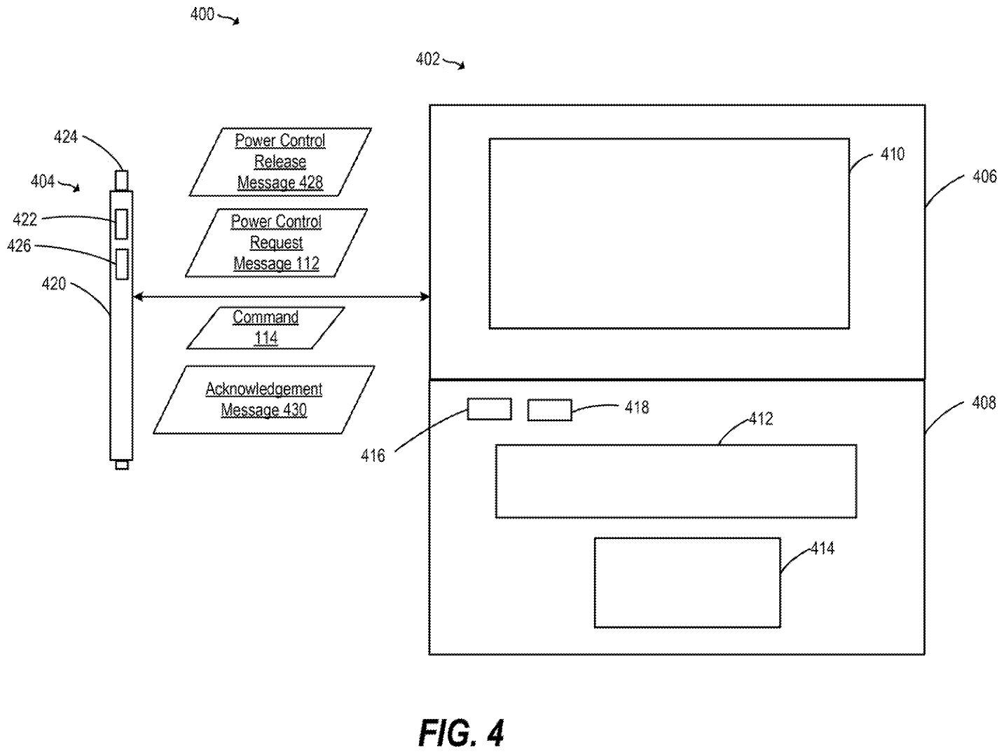

FIG. 4 illustrates a system 400 where an input device is to control a power state change of a laptop computer, according to an example. System 400 may include a computing device 402 and an input device 404. Computing device 402 may implement computing device 102 of FIGS. 1, 2A, and 2B. Input device 404 may implement external device 104 of FIG. 1—Computing device 402 may be implemented as a laptop computer and input device 404 may be implemented as a stylus.

Computing device 402 may include a first housing 406 and a second housing 408. First housing 406 may be connected to second housing 408 via a hinge (not shown in FIG. 4). A display device 410 may be disposed in first housing 406. A keyboard 412 and a touchpad 414 may be disposed in second housing 408.

Computing device 402 may also include a power button 416 and an indicator 418 that are disposed in second housing 408. Power button 416 may include a power switch, such as power switch 108 of FIG. 1. Input device 404 may include a housing 420, a first button 422, a second button 424, and an indicator 426.

During operation, a user of input device 404 may press first button 422 to transmit power control request message 112 to computing device 402. In response to receiving power control request message 112, computing device 402 may disable power button 416 and provide an indication via indicator 418 that power button 416 is disabled. In some examples, indicator 418 may be implemented using a Light-Emitting Diode (LED). Computing device 402 may turn on the LED (e.g., via controller, such as controller 106). In some examples, indicator 418 may be implemented using a speaker. Thus, computing device 402 may generate a sound (e.g., a beep) via the speaker to alert the user that power button 416 is disabled.

In some examples, computing device 402 may transmit an acknowledgement message 430 to input device 404. Acknowledgement message 430 may indicate that a wireless connection has been established between computing device 402 and input device 404, power control request message 112 has been received, input device 404 has been set to be the single power control device for computing device 402, or a combination thereof. In response to receiving acknowledgement message 430, input device 404 may provide an indication that power button 416 is disabled via indicator 426. For example, indicator 426 may be an LED. Thus, input device 404 may turn on the LED to indicate that power button 416 is disabled. In some examples, input device 404 may provide the indication in response to transmitting power control request message 112.

The user of input device 404 may press second button 424 to transmit command 114 to computing device 402 to control a power state change of computing device 402. To re-enable power button 416, the user may press first button 422 again (i.e., a subsequent press to the press that causes power control request message 112 to be transmitted) to transmit a power control release message 428 to computing device 402. When power button 416 is enabled, indicators 426 and 418 may be turned off.

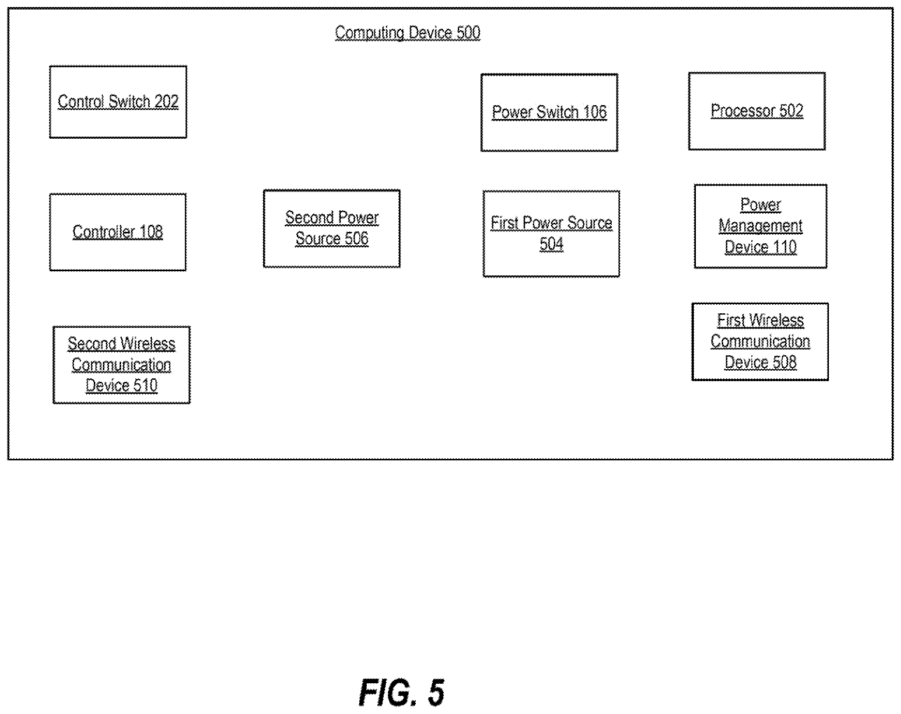

FIG. 5 illustrates a computing device 500 to receive a command from an external device to control a power state change, according to an example. Computing device 500 may implement computing device 102 of FIGS. 1, 2A, and 2B, computing device 402 of FIG. 4, or a combination thereof.

Computing device 500 may implement computing device 102 of FIGS. 1, 2A, and 2B and computing device 402 of FIG. 4. Computing device 500 may include power switch 108, controller 106, control switch 202, power management device 110, a processor 502, a first power source 504, a second power source 506, a first wireless communication device 508, and a second wireless communication device 510.

Processor 502 may control operations of computing device 500. Processor 502 may be a central processing unit (CPU), a semiconductor-based microprocessor, and/or other hardware devices suitable for retrieval and execution of instructions stored in a computer-readable storage medium. First power source 504 and second power source 506 may be hardware that converts electric current to a particular voltage and/or current. The particular voltage and/or current is then provided to component(s) of computing device 500. In some examples, first and second power source 504 and 506 may be an Alternate Current-to-Direct. Current (AC-to-DC) power supply circuit.

in some examples, first power source 504 and second power source 506 may be implemented as separate batteries. In some examples, first power source 504 may be implemented as a lithium-ion battery and second power source 506 may be implemented a complementary metal-oxide-semiconductor (CMOS) battery.

First power source 504 may be the main power source of computing device 500. That is, first power source 504 may provide power to a majority of components of computing device 500. For example, first power source 504 may provide power to processor 502, power switch 108, power management device 110, first wireless communication device 508, or a combination thereof.

Second power source 506 may provide power to controller 106, second wireless communication device 510, control switch 202, or a combination thereof. By having a separate power source for controller 106, controller 106 may remain powered on even when computing device 500 is to change from an on state to an off state. Thus, controller 106 may be able to control which entity (power switch 108 or external device 104) is to control a power state change of computing device 500 regardless of the status of first power source 504, Also, by providing power to a small set of components, second power source 506 may last much longer in a single charge than first power source 504.

First wireless communication device 508 and second wireless communication device 510 may be hardware or hardware and instructions that convert an electrical signal to a radio wave for transmission and a received radio wave to an electrical signal for processing. In some examples, first wireless communication device 508 and second wireless communication device 510 may be implemented using separate transceiver circuits. In some examples, first wireless communication device 508 and second wireless communication device 510 may each include an antenna.

In some examples, first wireless communication device 508 may implement a different frequency band and/or wireless communication specification than second wireless communication device 510. For example, first wireless communication device 508 may transmit and/or receive communication via frequency bands of 900 Megahertz (MHz), 2.4 Gigahertz (GHz), 3.6 GHz, 4.9 GHz, 5 GHz, 5.9 GHz and 60 GHz. Second wireless communication device 510 may transmit and/or receive communication via frequency bands between 300 MHz to 500 MHz. In some examples, first wireless communication device 508 may implement Wi-Fi® while second wireless communication device 510 may implement a different wireless communication specification, such as Bluetooth®.

In some examples, first wireless communication device 508 and second wireless communication device 510 may support the same frequency bands and/or wireless communication specifications, such as Wi-Fi®), Bluetooth®, etc.

In some examples, first wireless communication device 508 may be connected to processor 502 to transmit and/or receive data communication between computing device 500 and another entity (e.g., a network, another computing device, etc.). Second wireless communication device 510 may be connected to controller 108 to transmit and/or receive messages related to setting the power control device (e.g., power control release message 428, power control request message 112, acknowledgement message 430, etc.).

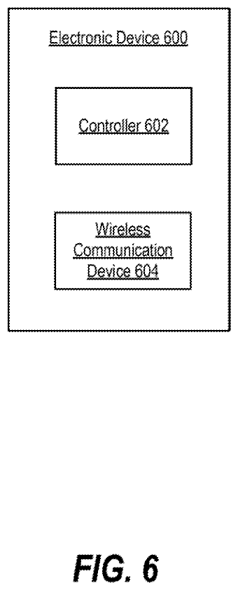

FIG. 6 illustrates an electronic device 600 to control a power state change of a computing device, according to an example. Electronic device 600 may implement external device 104 of FIG. 1 and input device 404 of FIG. 4. Electronic device 600 may include a controller 602 and a wireless communication device 604. Controller 602 may be a central processing unit (CPU), a semiconductor-based microprocessor, and/or other hardware devices suitable for retrieval and execution of instructions stored in a computer-readable storage medium. Wireless communication device 604 may be similar to second wireless communication device 510 of FIG. 5. In some examples, electronic device 600 may also include an additional wireless communication device (not shown in FIG. 6) that is similar to first wireless communication device 508 of FIG. 5.

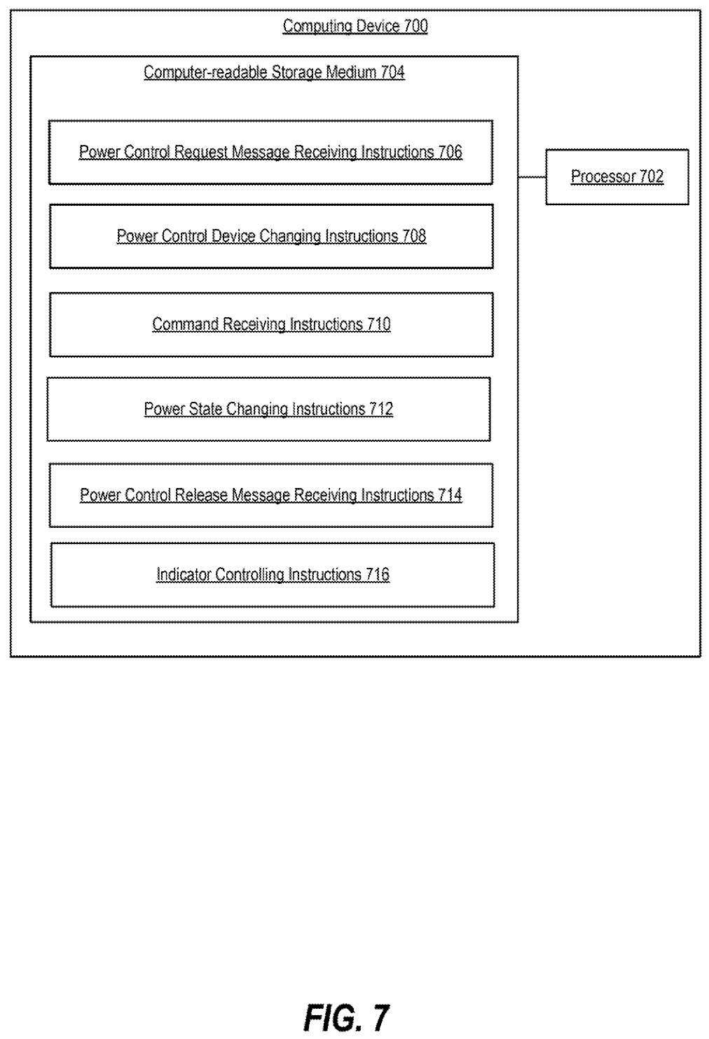

FIG. 7 illustrates a computing device 700 to receive a command from an external device to control a power state change, according to another example. Computing device 700 may implement computing device 102 of FIG. 1, 2A, 28, computing device 402 of FIG. 4, and computing device 500 of FIG. 5.

Processor 702 may be a central processing unit (CPU), a semiconductor-based microprocessor, and/or other hardware devices suitable for retrieval and execution of instructions stored in computer-readable storage medium 704. Processor 702 may fetch, decode, and execute instructions 706, 708, 710, 712, 714, and 716 to control operations of computing device 700. As an alternative or in addition to retrieving and executing instructions, processor 702 may include at least one electronic circuit that includes electronic components for performing the functionality of instructions 706, 708, 710, 712, 714, 716, or a combination thereof.

Computer-readable storage medium 704 may be any electronic, magnetic, optical, or other physical storage device that contains or stores executable instructions. Thus, computer-readable storage medium 704 may be, for example, Random Access Memory (RAM), an Electrically Erasable Programmable Read-Only Memory (EEPROM), a storage device, an optical disc, etc. In some examples, storage medium 704 may be a non-transitory storage medium, where the term “non-transitory” does not encompass transitory propagating signals. Computer-readable storage medium 704 may be encoded with a series of processor executable instructions 706, 708, 710, 712, 714, and 716.

Power control request message receiving instructions 706 may receive a power control request message from an external device. For example, referring to FIG. 1, computing device 102 may receive power control request message 112 from external device 104. Power control device changing instructions 708 may set a single device to be the power control device that controls a power state change of computing device 700. The device may be one of a power switch of computing device 700 or the external device. For example, referring to FIG. 1, in response to receiving power control request message 112, computing device 102 may set external device 104 as the device to control a power state change of computing device 102. Computing device 102 may also disable power switch 108 so that computing device 102 is not able to cause a power state change based on a command from power switch 108.

Command receiving instructions 710 may receiving a command to change a power state of computing device 700. For example, referring to FIG. 1, computing device 102 may receive command 114 from external device 104. Power state changing instructions 712 may change a power state of computing device 700. For example, referring to FIG. 1, in response to receiving command 114, computing device 102 may change a power state based on command 114, such as from working state to soft off state.

Power control release message receiving instructions 714 may receive a power control release message from the external device. For example, referring to FIG. 4, computing device 402 may receive power control release message 428 from input device 404. Indicator controlling instructions 716 may control an indicator of computing device 700 to indicate which device is set as the device to control a power state change of computing device 700. For example, referring to FIG. 4, computing device 402 may turn on indicator 418 in response to receiving power control request message 112. Computing device 402 may also turn off indicator 418 in response to receiving power control release message 428.

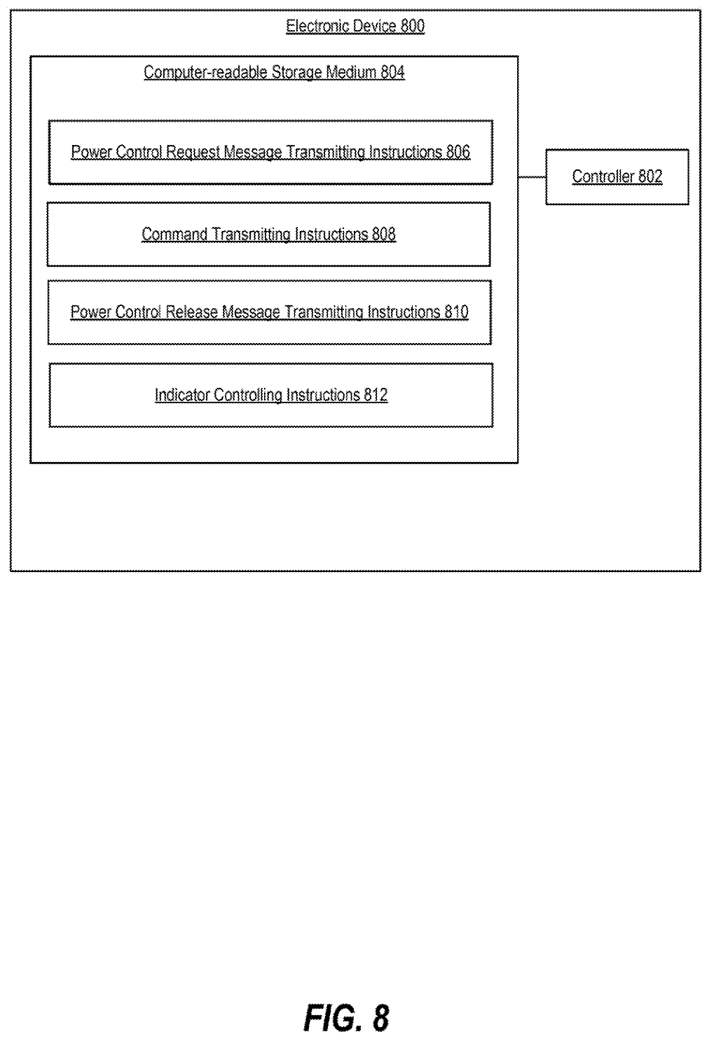

FIG. 8 illustrates an electronic device 800 to control a power state change of a computing device, according to another example. Electronic device 800 may implement external device 104 of FIG. 1, input device 404 of FIG. 4, and electronic device 600. Electronic device 800 may include a controller 802 and a computer-readable storage medium 804. Controller 802 may be similar to processor 702 and computer-readable storage medium 804 may be similar to computer-readable storage medium 704 of FIG. 7. Computer-readable storage medium 804 may be encoded with instructions 806, 808, 810, and 812.

Power control request message transmitting instructions 806 may transmit a power control request message to a computing device. For example, referring to FIG. 1, external device 104 may transmit power control request message 112 to computing device 102. Command transmitting instructions 808 may transmit a command to the computing device to change a power state of the computing device. For example, referring to FIG. 1, external device 104 may transmit command 114 to computing device 102 to cause a power state change at computing device 102.

Power control release message transmitting instructions 810 may transmit a power control release message to the computing device. For example, referring to FIG. 4, input device 404 may transmit power control release message 428 to computing device 402. Indicator controlling instructions 812 may control an indicator of electronic device 800 to indicate if electronic device 800 is set as the device to control a power state change of a computing device. For example, referring to FIG. 4, input device 404 may turn on indicator 426 in response to transmitting power control request message 112 and/or receiving acknowledgement message 430 from computing device 402. Input device 404 may also turn off indicator 426 in response to transmitting power control release message 428 and/or receiving a subsequent acknowledge message from computing device 402.

The use of “comprising′, “including” or “having” are synonymous and variations thereof herein are meant to be inclusive or open-ended and do not exclude additional unrecited elements or method steps.

What is claimed is:

1. A computing device comprising:
a power switch;
a power management device to control a power state change of the computing device based on a command from a power control device; and
a controller to: in response to receiving a power control request message from an external device, change the power control device from the power switch to the external device.

2. The computing device of claim 1 further compromising;
a housing; and
an indicator disposed in the housing, wherein the controller is to turn on the indicator in response to receiving the power control request message.

3. The computing device of claim 1′, wherein the power management device is to control the power state change based on a command from a single power control device.

4. The computing, device of claim 1, further comprising:
a first power source to provide power to the power management device; and
a second source to provide power to the cc nt oiler.

5. The computing device of claim 1, further comprising:
a control switch, wherein the controller is to change the power control device via the control switch.

6. A computing device comprising:
a power switch;
a power management device; and
a controller to:
in response to receiving a power control request message fror an external device, disable the power switch; and
in response to receiving a command from the external device, assert the command to the power management device to change a power state of the computing device.

7. The computing device of claim 6, wherein the controller is to:
in response to receiving a power control release message from the external device, connect the power switch to the power management device.

8. The computing device of claim 6, further compromising:
a first wireless communication device; and
a second wireless communication device connected to the controller.

9. The computing device of claim 6, wherein the controller is to remain powered on when the computing device is to change from an on state to an off state.

10. The computing device of claim 6, further comprising light-emitting diode (LED), wherein the controller is to:
turn on the LED in response to receiving the power control request message; and
turn off the LED in response to receiving a power control release message from the external device.

11. A system comprising:
a computing device having a power switch, wherein the power switch is to control a power state change of the computing device; and
an input device, wherein the input device is to:
transmit a power control request message to the computing device wirelessly to disable the power switch; and
transmit a command to the computing device to control the power state change.

12. The system of claim 11, wherein the input device includes a first button and a second button, wherein the input device is to transmit the power control request message in response to a press of the first button, and wherein the input device is to transmit the command in response to a press of the second button.

13. The system of claim 12, wherein the input device is to transmit a power control release message to the computing device in response to a subsequent press of the first button, and wherein the computing device is to re-enable the power switch in response to receiving the power control release message.

14. The system of claim 11, wherein the input device corresponds to a stylus, wherein the input device includes an indicator, wherein the input device is to turn on the indicator in response to establishing a wireless connection with the computing device.

15. The system of claim 11, wherein the computing device is to provide an indication that the power switch is disabled.
